(19) United States
(12) Patent Application Publication
(10) Pub. No.: US 2009/0183199 A1
(43) Pub. Date: Jul. 16, 2009

(54) Devices, Systems, and Methods Regarding Advertisement on Demand

(76) Inventors: James Ivan Stafford, Livermore, CA (US); Jun Shan Wey, Sammamish, WA (US)

Correspondence Address: MICHAEL N. HAYNES, 1341 HUNTERSFIELD CLOSE, KESWICK, VA, 22947, US

(21) Appl. No.: 11/972,212

(22) Filed: Jan. 10, 2008

(51) Int. Cl. H04N 7/10

(52) U.S. Cl. 725/34

(57) ABSTRACT

Certain exemplary embodiments can provide a method, which can comprise, responsive to a signal from a television control device, causing a display of a video advertisement. The video advertisement can interrupt the video broadcast. The signal can be adapted to cause a detection of a determined frame of a video broadcast interrupted by the display of the video advertisement.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system 1000;

FIG. 2 is a block diagram of an exemplary embodiment of a user interface 2000;

FIG. 3 is a block diagram of an exemplary embodiment of a user interface 3000;

FIG. 4 is a block diagram of an exemplary embodiment of a user interface 4000;

FIG. 5 is a block diagram of an exemplary embodiment of a sequence of video clips 5000;

FIG. 6 is a flowchart of an exemplary embodiment of a method 6000;

FIG. 7 is a flowchart of an exemplary embodiment of a method 7000;

FIG. 8 is a flowchart of an exemplary embodiment of a method 8000; and

FIG. 9 is a block diagram of an exemplary embodiment of an information device 9000.

### DETAILED DESCRIPTION

Certain exemplary embodiments can provide a method, which can comprise, responsive to a signal from a television control device, causing a display of a video advertisement. The video advertisement can interrupt the video broadcast. The signal can be adapted to cause a detection of a determined frame of a video broadcast interrupted by the display of the video advertisement.

Certain exemplary embodiments can relate to video broadcasts and/or video on-demand services for home entertainment environments. Certain exemplary embodiments can be provided by Internet Protocol Television (IPTV), cable, satellite, or any other video and internet service providers. Video service packages can comprise broadcast and on-demand programs, such as Pay-per-View, Video-on-Demand, Personal video recording, and pause-live-television.

Video-on-demand service can allow viewers the flexibility to choose and/or view from a large selection of video programs. Internet service when combined with video service can allow viewers to access the World Wide Web via a television set-top box (TV STB) while watching TV. Karaoke-on-demand service can allow viewers to choose from a large selection of audio/video karaoke programs and can be included in certain exemplary embodiments.

Middleware can be a software layer which controls interactions and/or communications among TV viewers, a TV STB, video servers, and/or head-end network gears in a central office. In certain exemplary embodiments, TV viewers can watch pre-determined advertisements in regular broadcast programs and/or skip advertisements by fast forwarding if the programs are pre-recorded. Certain exemplary embodiments can provide an option to selectively save, play back, and/or obtain additional information of a particular advertisement. In order to save and/or play back a particular advertisement, viewers can use a Personal Video Recorder (PVR) to record a video program with advertisements, then fast forward to a specific ad for play back, or use the PVR to record an advertisements portion of a video program. In certain exemplary embodiments, a recorded title shown can be a title of the video program and/or the title of the advertisement.

Certain exemplary embodiments can provide for on demand storage and/or retrieval of broadcast or unicast media information in a TV environment. Certain exemplary embodiments can manage advertisement content and/or can have applications beyond advertisements. Certain exemplary embodiments can provide for a method of handling and/or managing advertisements on TV to enhance viewers' TV watching experience.

Certain exemplary embodiments can allow a user to pull a video advertisement out of a channel and/or to store the video advertisement either on an Advertisement on Demand (AOD) server or on a hard disc drive in a TV STB. Viewers can save favorite advertisements and/or watch favorite advertisements anytime. For example, special advertisements and/or commercials created during special events, e.g., a Super Bowl broadcast, can have content that causes people to be interested in saving and viewing the special advertisements and/or commercials at a later time. The recording of advertisements can be similar as recording of content items for a PVR feature. Certain exemplary embodiments can treat each advertisement as an individual video clip and/or allow viewers to access each advertisement on demand.

In certain exemplary embodiments, a viewer can be provided an opportunity to watch advertisements and/or view web pages at their leisure by bookmarking web sites and/or saving an ad to a personal Ad channel. If a viewer chooses to do either during a live TV show, a watched broadcast can be recorded beginning at a first determined frame. The watched broadcast can be resumed when an advertisement and/or viewed web page is completed. In certain exemplary embodiments, PVR content can be available for Trickplay functions such as fast forward, rewind, and/or jump. Certain exemplary embodiments can provide a Uniform Resource Locator (URL) embedded in recorded content accessible for bookmarking.

In certain exemplary embodiments, viewers can watch advertisements any time and/or earn points or entries into contests. In certain exemplary embodiments, advertisers can pay to have advertisements available to viewers on demand. Certain exemplary embodiments can be applied to IPTV, cable, satellite, and/or video entertainment services via which advertisements can be provided.

Banner advertisements can be shown periodically, e.g., every 10 minutes, at the bottom or top of the screen during Live TV. Viewers can be offered options to view advertisements in full screen, go to the URL of the advertising company, and/or go to a saved advertisements channel. Ad information can be carried in-band. Pressing a remote control button (e.g., a fast-forward key) can trigger an ad display. Certain exemplary embodiments can offer updates to advertisements.

Certain exemplary embodiments can cause a television program to be paused and/or recorded when an ad is viewed. Viewers can watch full screen on-demand advertisements. Viewers can also have opportunities to enter contests, place votes, and/or play other interactive activities. Certain exemplary embodiments can allow a viewer to select advertisements, informational video, and/or web page content accessed via a URL. Certain exemplary embodiments can allow viewers to go to the URL of the company that is advertising and/or allow the viewers to bookmark the URL for future use. When the advertisement and/or web page content is complete, viewers can resume paused TV and continue watching TV.

Certain exemplary embodiments can provide a “My advertisements” channel. From there, viewers can view from a list of previously saved advertisements or save a current ad URL to the list. Certain exemplary embodiments can provide opportunities to viewers to perform interactive activities, such as entering contests and/or placing votes. Certain exemplary embodiments can resume paused TV and/or continue watching TV.

Certain exemplary embodiments can provide that when specific keys on a remote control are pressed to access AOD feature, a broadcast is paused. If the viewer is watching live television, a current viewing position can be stored and a live video stream continues to be recorded in a buffer. Once the viewer returns from (Advertisement on Demand) AOD viewing, the paused event can be resumed.

In certain exemplary embodiments, pressing a remote control key can send a message to the STB to select a desired function. In certain exemplary embodiments, it might not matter if Time-Shifted Television (TSTV) is already active. The start of the recording can be triggered by pressing a designated AOD button on the remote control. Pressing a designated AOD button can be equivalent to pressing a “Pause” button for a live and/or prerecorded TV feed, which can either starts TSTV recording, or marks the current position in the buffer if it is already active. The current live television/Video-on-Demand (VOD) play position can be stored on the STB.

In certain exemplary embodiments, playback can start when the viewer exits the AOD activity whether or not the viewer is already using TSTV. Accessing the AOD feature can comprise bringing up a Web Browser for a given URL or bringing up an AOD management screen where viewers can save a reference to the Ad in question. Playback can resume when viewers close a browser and/or management screen.

A remote control key can be designated as a URL info key. When URL info key is pressed and there is an URL attached to the video steam (live or PVR), client software can load the browser and/or launch the URL site. URL information can be provided in-band (use case 1) and/or provided via Electronic Program Guide (EPG) and/or VOD data from the server. Certain exemplary embodiments can provide a full screen web page and allow a viewer to watch live television on the screen at the same time. Available bandwidth can be a consideration regarding operative embodiments. An AOD Application Program Interface (API) can be utilized for notifications and/or message displays, etc. The API can be an interface for the client, STB, and/or AOD server. The API can be used by advertisers.

Advertisements can be provided via unicast or multicast by service providers. In certain exemplary embodiments, content providers can prepare separate video clips for advertisements available for AOD. Certain advertisements might not be available for on demand viewing. If there is additional fee for advertisers to list advertisements on demand, some of the advertisers might choose not to include advertisements. Advertising companies can pay additional fees to service providers to have their advertisements stored on an AOD server. Certain exemplary embodiments can provide an option of extra billing and/or a subscription for the AOD feature.

An Ad channel can be included in the EPG and can be treated similar to a VOD channel. Each ad can be treated as a VOD content item. Certain exemplary embodiments can assemble VOD type items in channel form and/or provide visibility in the EPG. For example, a personalized TV channel can be automatically created out of preselected on-demand and/or announced broadcast items. An AOD server can be a video-on-demand server. Advertisements can be stored on the AOD server and/or on non-volatile memory such as a hard disk drive in an STB. Bandwidth requirement can be similar to that of broadcast or VOD channels. In case URL information is accessed with a Pause-Live-Television (PLTV) function activated, a small increase of bandwidth consumption can result. Certain exemplary embodiments can share an existing VOD server for on demand Ad content storage.

Certain exemplary embodiments can allow viewers to obtain additional information, place votes, and/or enter contests. Additional bandwidth for operative embodiments can be relatively small. Viewers can manage and/or view advertisement similar to a VOD feature. Favorite advertisements can be viewed at a viewer's leisure. Certain exemplary embodiments can bill a user for accessing an AOD feature.

A viewer can choose to pull a video advertisement out of a channel and/or to store the video advertisement on an AOD server and/or on a hard disc drive of a TV STB. Viewers can save favorite advertisements and/or watch favorite advertisements whenever desired. Certain exemplary embodiments can automatically trigger a PLTV function when starting AOD features such as selecting advertisements, informational video, and/or URL content. The viewer can watch advertisements and/or view web pages via bookmarking web sites and/or saving an ad to a personal Ad channel. If a viewer chooses to watch advertisements and/or view web pages during a live TV show, certain exemplary embodiments can automatically provide a PLTV function.

Certain exemplary embodiments can make a URL embedded in PVR content accessible for bookmarking. Each advertisement can be treated as an individual video clip and/or viewers can access each advertisement on demand. Viewers can earn points and/or place entries into contests when advertisements are watched. The PLTV function can be automatic triggered when AOD features are started. When specific keys on a remote control are pressed to access AOD feature, a current event can be paused. If the viewer is watching live television, a current viewing position can be stored and a live television stream can continue to be recorded in a PLTV buffer. Once the viewer returns from AOD, the paused event can be automatically resumed.

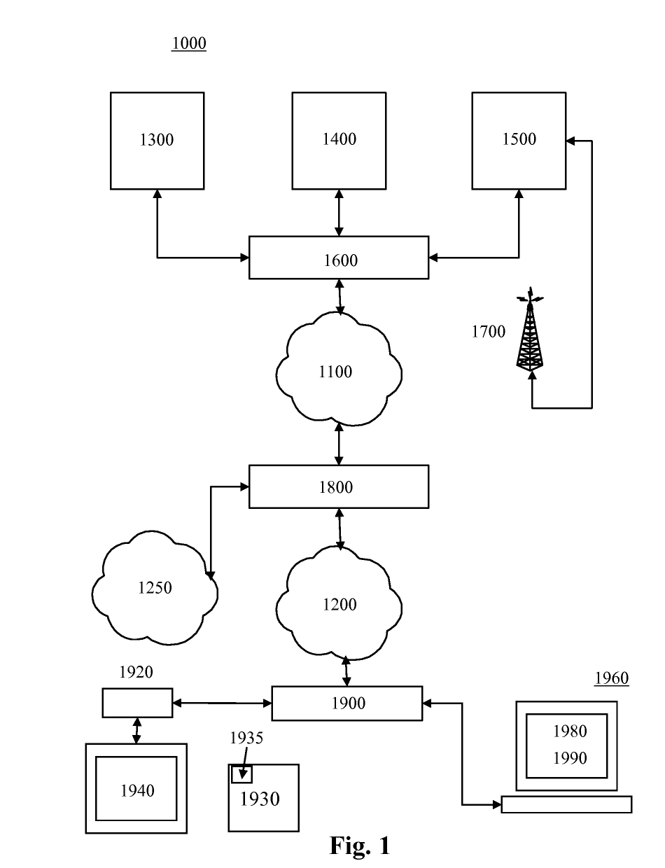

FIG. 1 is a block diagram of an exemplary embodiment of a system 1000, which can comprise an AOD server 1300, a VOD server 1400, and/or an encoder 1500. Encoder 1500 can be communicatively coupled to a wireless transceiver 1700. In certain exemplary embodiments, wireless transceiver 1700 can be adapted to receive video transmissions from a satellite, microwave network, wireless network, etc. Each of AOD server 1300, VOD server 1400, and encoder 1500 can be communicatively coupled to a first network 1100 by a router 1600. First network 1100 can be an Ethernet, Synchronous Optical Network (SONET), Asynchronous Transmission Mode (ATM), and/or ring network, etc. Router 1600 can be communicatively coupled to the Internet. First network 1100 can comprise and/or be communicatively coupled to one or more multiplexors such as add/drop multiplexers.

First network 1100 can be communicatively coupled to a second network 1200 via a router 1800. Second network 1200 can be an access network. Router 1800 can be communicatively coupled to a third network 1250, which can be a telephony network. Second network 1200 can be communicatively coupled to an information device 1960 and/or an STB 1920 via a modem 1900. Information device 1960 can comprise a user interface 1980 and/or a user program 1990. User interface 1980 can be adapted to render information regarding video broadcasts and/or AOD services. User program 1990 can be adapted to process information regarding video broadcasts and/or AOD services.

STB 1920 can be communicatively coupled to a television 1940, which can be adapted to render information such as digital television, Internet information, Pay-Per-View (PPV), VOD, AOD, and/or electronic commerce, etc. STB 1920 and/or television 1940 can be controlled via a television control device 1930, which can comprise one or more keys, such as key 1935. Key 1935 can be adapted to cause a signal to be transmitted to STB 1920. The signal can be adapted to cause a display of a video advertisement, such as a predetermined video advertisement. In certain exemplary embodiments, the video advertisement will have been prerecorded responsive to an instruction received via television control device 1930. The signal can be adapted to cause a detection of a first determined frame of a video broadcast interrupted by the display of a predetermined video advertisement. The signal can be adapted to cause the video broadcast to be recorded on a memory device beginning at the first determined frame. The signal can be adapted to cause the video broadcast to be resumed beginning at the first determined frame upon an automatically detected completion of the display of the video advertisement. The signal can be adapted to automatically cause a cessation of recordation of the video broadcast responsive to an automatically detected last frame of the video broadcast.

Certain exemplary embodiments can provide management software, content management, subscriber management, video service management, and/or asset management, etc.

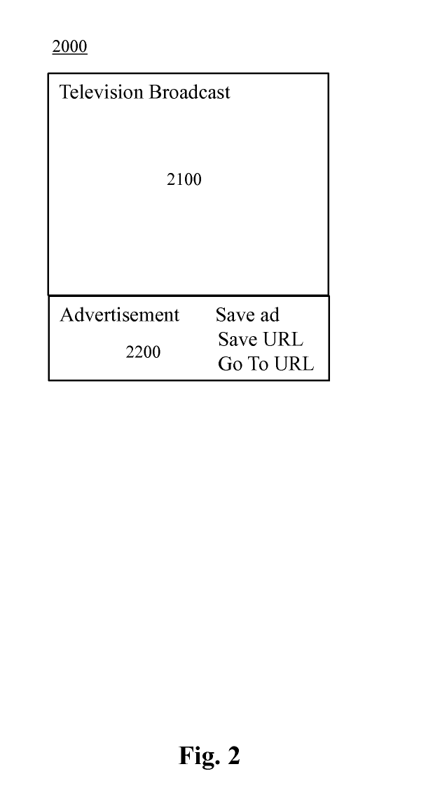

FIG. 2 is a block diagram of an exemplary embodiment of a user interface 2000, which can comprise a first portion 2100 and/or a second portion 2200. First portion 2100 can be adapted to render a television broadcast, such as live television. Second portion 2200 can be adapted to render advertisement information. In certain exemplary embodiments, second portion 2200 can provide a viewer with one or more selectable options, such as to save an advertisement, save a URL associated with the advertisement, and/or go to a web page corresponding to the URL, etc.

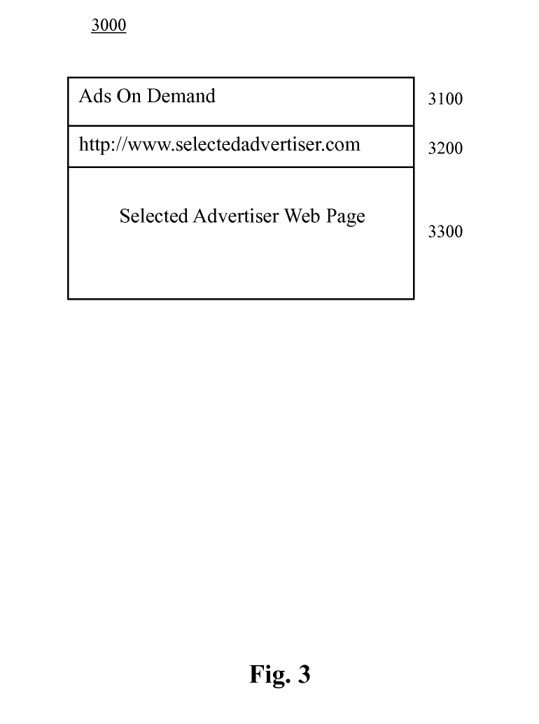

FIG. 3 is a block diagram of an exemplary embodiment of a user interface 3000, which can be indicative of a user interface rendering an advertisement on demand. User interface 3000 can comprise a first portion 3100, a second portion 3200, and/or a third portion 3300. First portion 3100 can be adapted to render a title of information rendered via user interface 3000. Second portion 3200 can be adapted to render a URL associated with an advertisement provided on demand. Third portion 3300 can be adapted to render a web page associated with the URL.

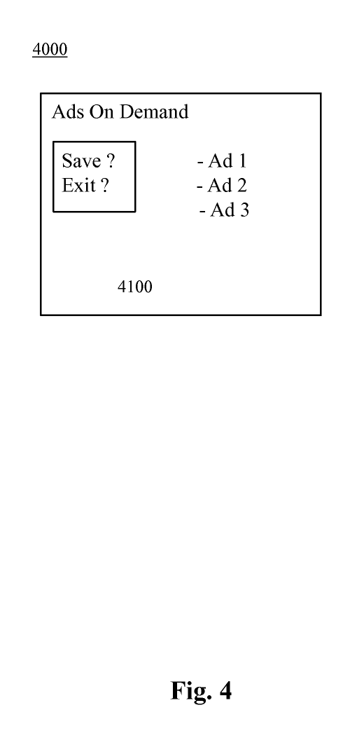

FIG. 4 is a block diagram of an exemplary embodiment of a user interface 4000, which can be adapted to allow a viewer to save one or more advertisements for AOD viewing. User interface 4000 can be adapted to render a list of advertisements selected by the viewer to be saved. User interface 4000 can provide the viewer with an option to save any listed advertisements and/or to resume a previously interrupted video broadcast.

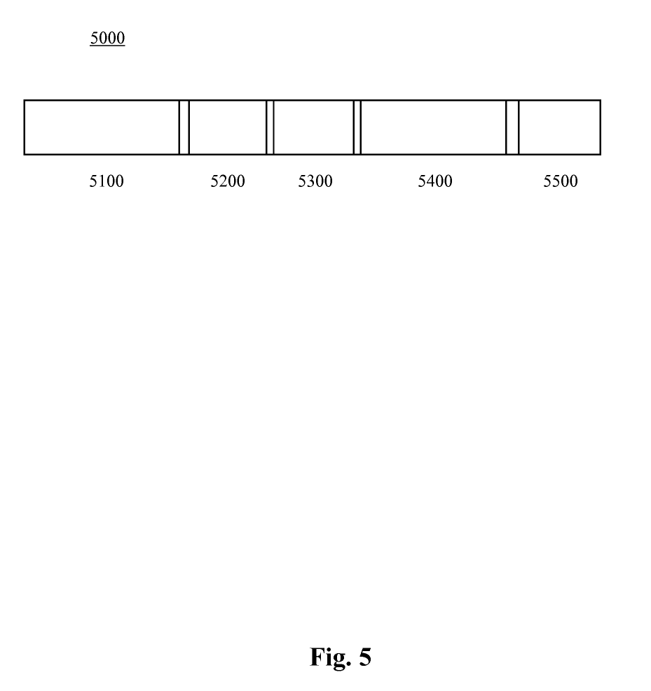

FIG. 5 is a block diagram of an exemplary embodiment of a sequence of video clips 5000, which can comprise a first video clip 5100, a second video clip 5200, a third video clip 5300, a fourth video clip 5400, and a fifth video clip 5500. First video clip 5100 can be a first portion of a video unicast, multicast, and/or broadcast that can comprise advertisements that are not provided on demand to the viewer. Second video clip 5200 can be a first AOD advertisement. Third video clip 5300 can be a second AOD advertisement. Fourth video clip 5400 can be a second portion of the video unicast, multicast, and/or broadcast that can comprise advertisements that are not provided on demand to the viewer. Fifth video clip 5500 can be a third AOD advertisement.

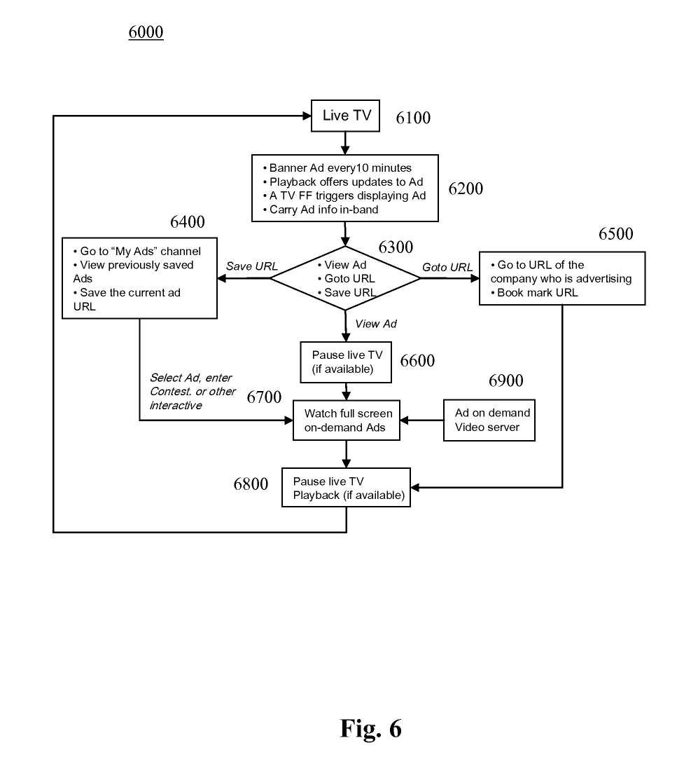

FIG. 6 is a flowchart of an exemplary embodiment of a method 6000. At activity 6100, a viewer can watch live television. At activity 6200, a banner advertisement can be repeated periodically, such as approximately every ten minutes. In certain exemplary embodiments, playback can offer updates to advertisements. A fast forward button of a remote control can trigger a display of an advertisement. The advertisement can carry advertisement information as an in-band signal.

At activity 6300, a user can view an advertisement, provide instructions for a web browser to go to a URL, and/or the URL can be saved on a memory device. At activity 6400, an instruction can be provided to go to a “My Ads” channel, a user can view previously saved advertisements, and/or a current advertisement can be saved. At activity 6500, an instruction can be provided and/or received for the web browser to the URL of the company that provides the advertisement. In certain exemplary embodiments, the URL can be bookmarked.

At activity 6600, the live television broadcast can be paused. The live television broadcast can be recorded on a memory device for later playback, such as at activity 6800. At activity 6700, a full screen on-demand advertisement can be watched by the viewer. At activity 6800, the live television can be time shifted and/or played back from the memory device. At activity 6900, the video server can provide the advertisement to the television for viewing by the viewer.

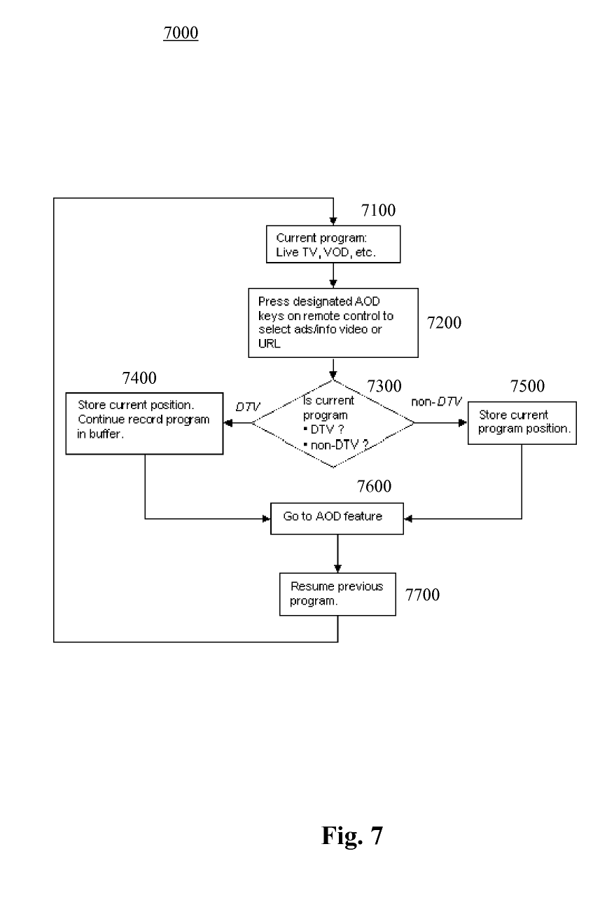

FIG. 7 is a flowchart of an exemplary embodiment of a method 7000. At activity 7100, a live television program and/or a video-on-demand program can be rendered to a television. At activity 7200, a viewer can press one or more designated AOD keys on a remote control to select advertisements, informational videos, and/or a web page that can be accessed via a URL. At activity 7300, a determination can be made whether a current program viewed via the television is a live television program and/or a non-live television (e.g., PVR, VOD, etc) program.

At activity 7400, if the current program is a live television program, a current position of the program can be stored and certain exemplary embodiments can record the current program in a buffer for later playback. At activity 7500, if the current program is a non-live television program, a current position of the program can be stored. At activity 7600, an AOD feature can be provided, which can cause an advertisement to be displayed on the television. At activity 7700, the live television program and/or a video-on-demand program can be resumed via the television.

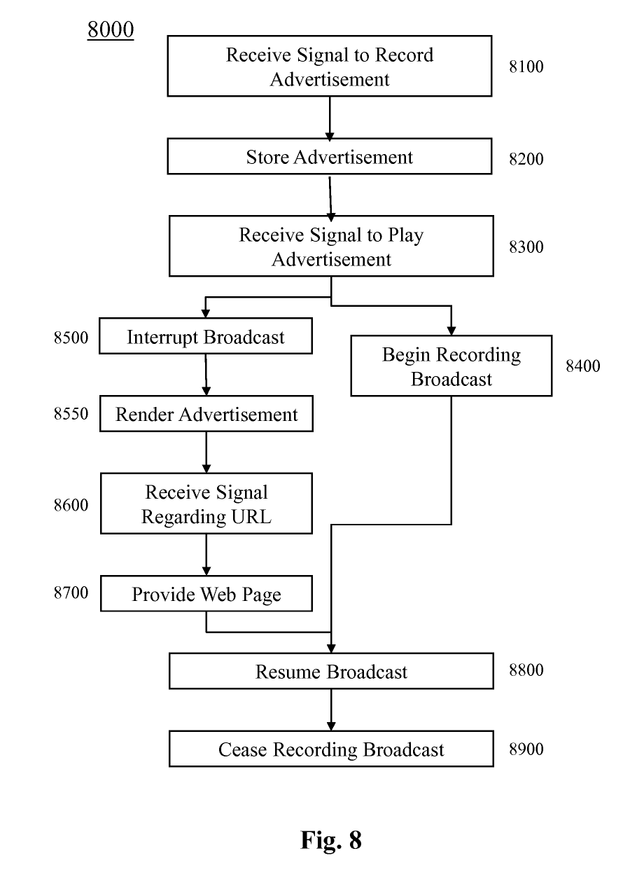

FIG. 8 is a flowchart of an exemplary embodiment of a method 8000. Activities of method 8000 can be implemented individually, in subsets, and/or as a set manually and/or automatically. In certain exemplary embodiments, one or more activities of method 8000 can be implemented as machine instructions, which can be stored on a machine-readable medium. At activity 8100, a first signal indicative of an instruction to record an advertisement can be received. The first signal can be adapted to cause a beginning frame of the advertisement, which can be a video advertisement, to be automatically detected. The first signal can be adapted to cause an ending frame of the advertisement to be automatically detected.

At activity 8200, the advertisement can be stored on a memory device. The first signal can be adapted to automatically cause the advertisement to be recorded on the memory device, a video recorder, a Television Set Top Box, and/or an Advertisement on Demand server. The advertisement can be automatically stored as a video clip responsive to the first signal.

At activity 8300, a second signal can be received, which can be indicative of an instruction to play an advertisement. The second signal can be responsive to an action of a user of a television control device.

At activity 8400, a first frame of a video broadcast and/or clip can be determined. The first frame can be indicative of a location at with the video broadcast and/or clip is to be interrupted in order to play the advertisement. The second signal from the television control device can be adapted to cause a detection of the first determined frame of the video broadcast and/or clip. The second signal can be adapted to cause the video broadcast to be recorded on a memory device beginning at the first determined frame.

At activity 8500, the broadcast and/or clip can be interrupted by a display of the video advertisement, which can be a predetermined video advertisement.

At activity 8550, the advertisement can be rendered and/or displayed responsive to the second signal from a television control device. The second signal can be adapted to cause a display of the video advertisement, which can be a predetermined video advertisement pre-recorded from a video stream responsive to the first signal from the television control device.

At activity 8600, a video signal that is indicative of a URL can be received in the broadcast and/or clip. Certain exemplary embodiments can be adapted to automatically display information obtained via the Internet regarding an organization associated with the URL, such as for example a company associated with the advertisement. The URL can be present as metadata in an analog and/or digital broadcast and/or clip. A display of the URL can occur responsive to a third signal from the television control device. In certain exemplary embodiments, the television control device can be adapted to allow the user of the television control device to save the URL in a memory device as a favorite URL.

At activity 8700, a web page can be provided and/or received responsive to a selection by the viewer of an option to view the web page associated with the URL. The television control device can be adapted to cause a display of the web page responsive to a user selection of the URL, which can be embedded in the video advertisement. The web page can be displayed responsive to a received fourth signal caused by an action of the user of the television control device. The fourth signal can be adapted to cause a detection of a first determined frame of the broadcast and/or clip interrupted by the display of the URL or the user selection of the URL. The fourth signal can be adapted to cause the video broadcast to be recorded on the memory device beginning at the first determined frame.

At activity 8800, a playing of the broadcast and/or clip can be resumed beginning at the first frame. The second signal and/or the fourth signal can be adapted to cause the broadcast and/or clip to be resumed beginning at the first determined frame upon an automatically detected completion of the display of the video advertisement, the display of the URL, and/or the display of the web page. In certain exemplary embodiments, upon an automatically detected completion of the display of the video advertisement, the broadcast and/or clip can be automatically resumed beginning at the first determined frame. In certain exemplary embodiments, upon an automatically detected completion of the display of the web page, the broadcast and/or clip can be automatically resumed beginning at the first determined frame.

At activity 8900, a recording of the broadcast and/or clip, which began with the first clip determined at activity 8400, can be ceased. The recording can be ceased responsive to an automatically detected last frame of the broadcast and/or clip. The last frame can be detected based upon a detected time associated with completion of the broadcast, metadata embedded in the broadcast and/or clip, and/or a predetermined frame in the broadcast and/or clip, etc. The fourth signal can be adapted to automatically cause a cessation of recordation of the video broadcast responsive to an automatically detected last frame of the video broadcast. In certain exemplary embodiments, the television control device can be a remote control. In certain exemplary embodiments, the first signal, the second signal, and/or the third signal can result from the user pressing a button of the remote control.

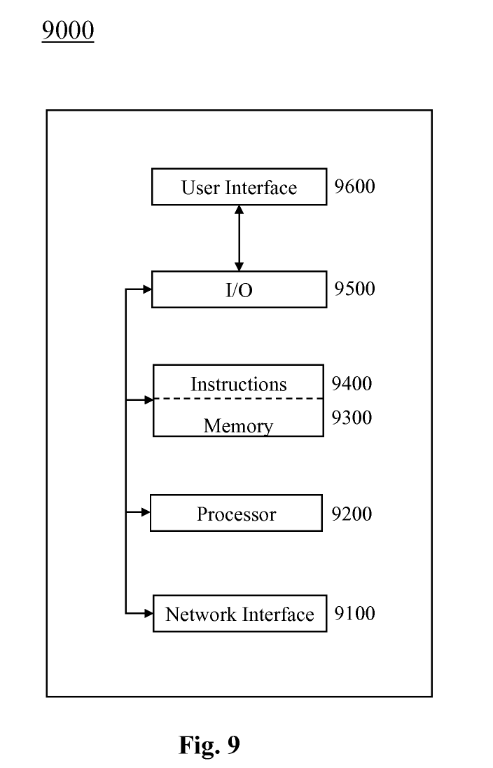

FIG. 9 is a block diagram of an exemplary embodiment of an information device 9000, which in certain operative embodiments can comprise, for example, information device 1960 of FIG. 1. Information device 9000 can comprise any of numerous components, such as for example, one or more network interfaces 9100, one or more processors 9200, one or more memories 9300 containing instructions 9400, one or more input/output (I/O) devices 9500, and/or one or more user interfaces 9600 coupled to I/O device 9500, etc.

In certain exemplary embodiments, via one or more user interfaces 9600, such as a graphical user interface, a user can view a rendering of information related to researching, designing, modeling, creating, developing, building, manufacturing, operating, maintaining, storing, marketing, selling, delivering, selecting, specifying, requesting, ordering, receiving, returning, rating, and/or recommending any of the products, services, methods, and/or information described herein.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
access—(n) a permission, liberty, right, mechanism, or ability to enter, approach, communicate with and/or through, make use of, and/or pass to and/or from a place, thing, and/or person; (v) to enter, approach, communicate with and/or through, make use of, and/or pass to and/or from.
action—(n) a deed, act, activity, performance of a deed, act, and/or activity, and/or something done and/or accomplished. (v) to perform a deed, act, and/or activity.
activity—an action, act, deed, function, step, and/or process and/or a portion thereof.
adapted to—suitable, fit, and/or capable of performing a specified function.
add—to combine.
address—(n.) one or more identifiers, such as one or more symbols, characters, names, and/or numbers, used for identification in information transmission, storage, and/or retrieval, the one or more identifiers assignable to a specific physical, logical, and/or virtual machine, process, node, object, entity, record, data element, component, port, interface, location, link, route, circuit, and/or network; (v.) to locate, access, assign, and/or provide an identifier a specific physical, logical, and/or virtual machine, process, node, object, entity, record, data element, component, port, interface, location, link, route, circuit, and/or network.
advertisement—a notice, such as a paid announcement, designed to attract public attention and/or patronage.
allow—to provide, let do, happen, and/or permit.
analyze—to review, study, examine, evaluate, and/or consider in detail and/or to subject to an analysis in order to discover essential features and/or meaning.
and/or—either in conjunction with or in alternative to.
apparatus—an appliance or device for a particular purpose.
approximately—about and/or nearly the same as.
assist—to give help or support to.
associated—related to and/or accompanying.
associated with—related to.
at least—not less than.
automatic—performed via an information device in a manner essentially independent of influence and/or control by a user.
automatically—acting and/or operating in a manner essentially independent of external human influence and/or control. For example, an automatic light switch can turn on upon “seeing” a person in its view, without the person manually operating the light switch.
based—being derived from.
based upon—determined in consideration of and/or derived from.
begin—to start.
between—in a separating interval and/or intermediate to.
broadcast—(n) a transmitted sequence of frames that forms an audio, video, and/or data stream, the frames transmitted to two or more recipients simultaneously; (v) to transmit a sequence of frames that forms an audio, video, and/or data stream to two or more recipients simultaneously.
can—is capable of, in at least some embodiments.
cause—to bring about, provoke, precipitate, produce, elicit, be the reason for, result in, and/or effect.
cease—to stop.
circuit—an electrically conductive pathway and/or a communications connection established across two or more switching devices comprised by a network and between corresponding end systems connected to, but not comprised by the network.
clip—a defined portion of an audio, video, and/or data broadcast.
communicate—to exchange information.
communication—a transmission and/or exchange of information.
communications link—an established communication channel.
communicatively—linking in a manner that facilitates communications.
communicatively couple—to link in a manner that facilitates communications.
compare—to examine in order to note similarities or differences between at least two items.
complete—to substantially fully provide required and/or requested information.
comprise—to include but not be limited to.
comprised by—included by.
control—(n) a mechanical or electronic device used to operate a machine within predetermined limits; (v) to exercise authoritative and/or dominating influence over, cause to act in a predetermined manner, direct, adjust to a requirement, and/or regulate.
couple—to join, connect, and/or link two things together.
data—information represented in a form suitable for processing by an information device.
database—one or more structured sets of persistent data, usually associated with software to update and query the data. A simple database might be a single electronic file containing many records, each of which is structured using the same set of fields.
define—to establish the meaning, relationship, outline, form, and/or structure of, and/or to precisely and/or distinctly describe and/or specify.
detect—to sense, perceive, identify, discover, ascertain, respond to, and/or receive the existence, presence, and/or fact of.
determine—to obtain, calculate, decide, deduce, establish, and/or ascertain.
determination—(n) a decision; (v) to make and/or arrive at a decision.
device—a machine, manufacture, and/or collection thereof.
display—(v.) to visually render. (n.) an electronic device that represents information in visual form and/or a visual representation of something.
dynamically—on demand or as necessary.
each—every one of a group considered individually.
either—one or the other of two.
embed—to cause to be an integral part of a whole.
end—a concluding part.
establish—to create, form, and/or set-up.
favorite—a selected stored address.
first—an initial element in an ordered plurality of elements.
for—with a purpose of.
frame—one of a series of images, audio signals, and/or data signals of an ordered plurality of images, audio signals, and/or data signals that are used in a broadcast stream.
from—used to indicate a source.
further—in addition.
if—in case that.
indicative—serving to indicate.
information—facts, terms, concepts, phrases, expressions, commands, numbers, characters, and/or symbols, etc., that are related to a subject. Sometimes used synonymously with data, and sometimes used to describe organized, transformed, and/or processed data. It is generally possible to automate certain activities involving the management, organization, storage, transformation, communication, and/or presentation of information.
information device—any device on which resides a finite state machine capable of implementing at least a portion of a method, structure, and/or or graphical user interface described herein. An information device can comprise well-known communicatively coupled components, such as one or more network interfaces, one or more processors, one or more memories containing instructions, one or more input/output (I/O) devices, and/or one or more user interfaces (e.g., coupled to an I/O device) via which information can be rendered to implement one or more functions described herein. For example, an information device can be any general purpose and/or special purpose computer, such as a personal computer, video game system (e.g., PlayStation, Nintendo Gameboy, X-Box, etc.), workstation, server, minicomputer, mainframe, supercomputer, computer terminal, laptop, wearable computer, and/or Personal Digital Assistant (PDA), iPod, mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, a digital signal processor, an ASIC or other integrated circuit, a hardware electronic logic circuit such as a discrete element circuit, and/or a programmable logic device such as a PLD, PLA, FPGA, or PAL, or the like, etc.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
instruction—a direction adapted to perform a particular operation or function.
interface—(n) an addressable device for communicatively coupling an entity (such as a router, server, switch, softswitch, gateway, etc.) to a packet network, the addressable device comprising hardware, firmware, and/or software, etc. The entity can have multiple interfaces, each of which can be addressable via one or more packet networks. (v) to connect with and/or interact with by way of an interface.
Internet—a globally interconnected system of data networks.
interrupt—to terminate a flow of a broadcast.
key—a surface that when touched, pressed, moved, and/or actuated is adapted to cause a signal to be transmitted to a receiving device and/or system, the signal adapted to cause a predetermined action.
last—a final item of a plurality of items.
machine instructions—directions adapted to cause a machine, such as an information device, to perform one or more particular activities, operations, and/or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine-readable medium—a physical structure from which a machine, such as an information device, computer, microprocessor, and/or controller, etc., can obtain and/or store data, information, and/or instructions. Examples include memories, punch cards, and/or optically readable forms, etc.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
message—a communication.
method—a process, procedure, and/or collection of related activities for accomplishing something.
network—a communicatively coupled plurality of nodes, communication devices, and/or information devices. Via a network, such devices can be linked, such as via various wireline and/or wireless media, such as cables, telephone lines, power lines, optical fibers, radio waves, and/or light beams, etc., to share resources (such as printers and/or memory devices), exchange files, and/or allow electronic communications therebetween. A network can be and/or can utilize any of a wide variety of sub-networks and/or protocols, such as a circuit switched, public-switched, packet switched, connection-less, wireless, virtual, radio, data, telephone, twisted pair, POTS, non-POTS, DSL, cellular, telecommunications, video distribution, cable, terrestrial, microwave, broadcast, satellite, broadband, corporate, global, national, regional, wide area, backbone, packet-switched TCP/IP, IEEE 802.03, Ethernet, Fast Ethernet, Token Ring, local area, wide area, IP, public Internet, intranet, private, ATM, Ultra Wide Band (UWB), Wi-Fi, BlueTooth, Airport, IEEE 802.11, IEEE 802.11a, IEEE 802.11b, IEEE 802.11g, X-10, electrical power, multi-domain, and/or multi-zone sub-network and/or protocol, one or more Internet service providers, and/or one or more information devices, such as a switch, router, and/or gateway not directly connected to a local area network, etc., and/or any equivalents thereof.
network interface—any physical and/or logical device, system, and/or process capable of coupling an information device to a network. Exemplary network interfaces comprise a telephone, cellular phone, cellular modem, telephone data modem, fax modem, wireless transceiver, Ethernet card, cable modem, digital subscriber line interface, bridge, hub, router, or other similar device, software to manage such a device, and/or software to provide a function of such a device.
obtain—to receive, get, take possession of, procure, acquire, calculate, determine, and/or compute.
occur—to take place.
on-demand—occurring in response to a request.
organization—a for profit, non-profit, and/or governmental entity, and/or a component entity thereof and/or a structural unit.
packet—a generic term for a bundle of data organized in a specific way for transmission, such as within and/or across a network, such as a digital packet-switching network, and comprising the data to be transmitted and certain control information, such as a destination address.
plurality—the state of being plural and/or more than one.
predetermined—established in advance.
pre-recorded—stored in a memory device at a prior time.
press—to touch, move, and/or actuate.
processor—a hardware, firmware, and/or software machine and/or virtual machine comprising a set of machine-readable instructions adaptable to perform a specific task. A processor can utilize mechanical, pneumatic, hydraulic, electrical, magnetic, optical, informational, chemical, and/or biological principles, mechanisms, signals, and/or inputs to perform the task(s). In certain embodiments, a processor can act upon information by manipulating, analyzing, modifying, and/or converting it, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
provide—to furnish, supply, give, convey, send, and/or make available.
receive—to gather, take, acquire, obtain, accept, get, and/or have bestowed upon.
record—to store information in a retrievable form.
recorder—a device and/or system adapted to store video information, audio information, and/or data.
regarding—pertaining to.
remote control button—a surface of a device, which when touched, pressed, moved, and/or actuated is adapted to cause a signal to be transmitted to a television, the signal adapted to cause a predetermined action to take place.
render—to display, annunciate, speak, print, and/or otherwise make perceptible to a human, for example as data, commands, text, graphics, audio, video, animation, and/or hyperlinks, etc., such as via any visual, audio, and/or haptic means, such as via a display, monitor, printer, electric paper, ocular implant, cochlear implant, speaker, etc.
request—(v.) to express a need and/or desire for; to inquire and/or ask for. (n.) that which communicates an expression of desire and/or that which is asked for.
resource—something used for support or help.
responsive—reacting to an influence and/or impetus.
result—an outcome and/or consequence of a particular action, operation, and/or course.
resume—to take up again after interruption.
said—when used in a system or device claim, an article indicating a subsequent claim term that has been previously introduced.
save—retain data in a memory device.
second—an element that immediately follows an initial element in an ordered plurality of elements.
selection—(n) a choice; (v) to choose and/or select.
selected—a chosen item.
send—to convey.
server—an information device and/or a process running thereon that is adapted to be communicatively coupled to a network and that is adapted to provide at least one service for at least one other information device communicatively coupled to the network and/or for at least one process running on the other information device. A common example is a file server, which has a local disk and services requests from remote clients to read and write files on that disk. A server can also provide access to resources, such as programs, shared devices, etc.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
store—to place, hold, retain, enter, and/or copy into and/or onto a machine-readable medium.
stream—a series of transmitted data elements.
substantially—to a considerable, large, and/or great, but not necessarily whole and/or entire, extent and/or degree.
system—a collection of devices, machines, articles of manufacture, and/or processes, the collection designed to perform one or more specific functions.
television—a device and/or system that comprises a monitor adapted to render audio and/or video broadcast signals coupled with a tuner adapted to determine which of a plurality of received audio and/or video broadcast signals are rendered via the monitor.
Television Set Top Box (TVSTB)—a device and/or system that is adapted to receive a signal provided via a cable, satellite, aerial, and/or wired connection (e.g., a telephone line), to decode, demodulate, decrypt, and/or process the signal, to provide the resulting signal to a television, and receive and process commands from user's remote control key presses to change channel, change volume, perform trickplay, record programs, etc.
transmit—to provide, furnish, supply, send as a signal, and/or to convey (e.g., force, energy, and/or information) from one place and/or thing to another.
Uniform Resource Locator (URL)—an address that specifies a location of a file accessible via the Internet.
upon—soon after.
user—a person, organization, process, device, program, protocol, and/or system that uses a device, system, process, and/or service.
user interface—a device and/or software program for rendering information to a user and/or requesting information from the user. A user interface can include at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
utilize—to use and/or put into service.
via—by way of and/or utilizing.
video—humanly visible and varying images.
web page—a document on the Internet, identified by a Uniform Resource Locator.
wherein—in regard to which; and; and/or in addition to.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive.

What is claimed is:

1. A method comprising:
responsive to a first signal from a television control device, causing a display of a predetermined video advertisement, said video advertisement pre-recorded from a video stream responsive to a second signal from said television control device, said first signal adapted to cause a detection of a first determined frame of a video broadcast interrupted by said display of said predetermined video advertisement, said first signal adapted to cause said video broadcast to be recorded on a memory device beginning at said first determined frame, said television control device adapted to cause a display of a web page responsive to a user selection of a Uniform Resource Locator (URL) embedded in said video advertisement, said first signal adapted to cause said video broadcast to be resumed beginning at said first determined frame upon an automatically detected completion of said display of said video advertisement or said display of said web page.

2. The method of claim 1, further comprising:
receiving said first signal responsive to an action of a user of said television control device.

3. The method of claim 1, further comprising:
receiving said second signal responsive to an action of a user of said television control device.

4. The method of claim 1, further comprising:
responsive to said second signal, automatically detecting a beginning frame of said video advertisement.

5. The method of claim 1, further comprising:
responsive to said second signal, automatically detecting an ending frame of said video advertisement.

6. The method of claim 1, further comprising:
automatically causing said video advertisement to be recorded on said memory device responsive to said second signal.

7. The method of claim 1, further comprising:
automatically causing said video advertisement to be recorded on a video recorder responsive to said second signal.

8. The method of claim 1, further comprising:
automatically displaying information obtained via the Internet regarding an organization associated with said URL.

9. The method of claim 1, further comprising:
responsive to said second signal, automatically storing said video advertisement as a video clip.

10. The method of claim 1, further comprising:
responsive to said second signal, automatically storing said video advertisement as a video clip on an Advertisement on Demand server.

11. The method of claim 1, further comprising:
responsive to said second signal, automatically storing said video advertisement as a video clip on a Television Set Top Box.

12. The method of claim 1, further comprising:
upon an automatically detected completion of said display of said video advertisement, automatically resuming said video broadcast beginning at said first determined frame.

13. The method of claim 1, further comprising:
upon an automatically detected completion of said display of said web page, automatically resuming said video broadcast beginning at said first determined frame.

14. The method of claim 1, further comprising:
automatically detecting completion of said display of said video advertisement.

15. The method of claim 1, further comprising:
automatically ceasing recordation of said video broadcast on said memory device responsive to an automatically detected last frame of said video broadcast.

16. The method of claim 1, wherein said first signal results from a user pressing a remote control button.

17. The method of claim 1, wherein said second signal results from a user pressing a remote control button.

18. The method of claim 1, wherein said television control device is a remote control.

19. A machine-readable medium comprising machine instructions for activities comprising:
responsive to a signal from a television control device, causing a display of a predetermined video advertisement, said signal adapted to cause a detection of a first determined frame of a video broadcast interrupted by said display of a predetermined video advertisement, said signal adapted to cause said video broadcast to be recorded on a memory device beginning at said first determined frame, said signal adapted to cause said video broadcast to be resumed beginning at said first determined frame upon an automatically detected completion of said display of said video advertisement, said signal adapted to automatically cause a cessation of recordation of said video broadcast responsive to an automatically detected last frame of said video broadcast.

20. A method comprising:
responsive to a signal from a television control device, causing a display of a Uniform Resource Locator (URL), said television control device adapted to cause a display of a web page responsive to a user selection of said URL, said television control device adapted to allow a user of said television control device to save said URL in a memory device as a favorite URL, said signal adapted to cause a detection of a first determined frame of a video broadcast interrupted by said display of said URL or said user selection of said URL, said signal adapted to cause said video broadcast to be recorded on a memory device beginning at said first determined frame, said signal adapted to cause said video broadcast to be resumed beginning at said first determined frame upon an automatically detected completion of said display of said URL or said display of said web page, said signal adapted to automatically cause a cessation of recordation of said video broadcast responsive to an automatically detected last frame of said video broadcast.

21. A television control device comprising:
a key adapted to cause a signal to be transmitted to a set top box, said signal adapted to cause a display of a predetermined video advertisement, said signal adapted to cause a detection of a first determined frame of a video broadcast interrupted by said display of a predetermined video advertisement, said signal adapted to cause said video broadcast to be recorded on a memory device beginning at said first determined frame, said signal adapted to cause said video broadcast to be resumed beginning at said first determined frame upon an automatically detected completion of said display of said video advertisement, said signal adapted to automatically cause a cessation of recordation of said video broadcast responsive to an automatically detected last frame of said video broadcast.

22. A system comprising:
a television control device that comprises a key adapted to cause a signal to be transmitted to a set top box, said signal adapted to cause a display of a video advertisement that has been prerecorded responsive to an instruction received via said television control device, said signal adapted to cause a detection of a first determined frame of a video broadcast interrupted by said display of a predetermined video advertisement, said signal adapted to cause said video broadcast to be recorded on a memory device beginning at said first determined frame, said signal adapted to cause said video broadcast to be resumed beginning at said first determined frame upon an automatically detected completion of said display of said video advertisement, said signal adapted to automatically cause a cessation of recordation of said video broadcast responsive to an automatically detected last frame of said video broadcast; and
said set top box.
